(19) United States
(12) Patent Application Publication
(10) Pub. No.: US 2019/0306130 A1
(43) Pub. Date: Oct. 3, 2019

(54) CONNECTIVITY-BASED PORT SCRAMBLING

(71) Applicant: Cyber 2.0 (2015) LTD., Tel Aviv (IL)

(72) Inventor: Erez Kaplan Haelion, Rehovot (IL)

(73) Assignee: Cyber 2.0 (2015) LTD., Tel Aviv (IL)

(21) Appl. No.: 15/937,380

(22) Filed: Mar. 27, 2018

(51) Int. Cl. H04L 29/06; H04L 9/08; H04L 12/24

(52) U.S. Cl. CPC H04L 63/0428; H04L 9/0891; H04L 67/10; H04L 9/083; H04L 41/12

(57) ABSTRACT

System, product and method for connectivity-based scrambling is disclosed. Port scrambling mode is selected based on connectivity to a network. In one mode, ports of authorized outgoing communications are scrambled, while ports of unauthorized outgoing communications remain unscrambled. In another mode, ports of unauthorized outgoing communications are scrambled, while ports of authorized outgoing communications remain unscrambled. In some cases, under the first mode, ports of all incoming communications are descrambled, wile in the second mode, ports of all incoming communications remain unscrambled.

### TECHNICAL FIELD

The present disclosure relates to computer network communication in general, and to port scrambling for secure network communications, in particular.

### BACKGROUND

Computer networks are prevalent among many enterprises and organizations. Typically, a network environment comprises a plurality of computerized devices interconnected to one another and sharing resources, such as, for example, through common access to one or more servers connected to the network. In many cases, some or even all of the devices in the network environment are simultaneously connected also to one or more external networks, such as the World Wide Web. As a result, any of the devices in the internal network environment are made much more susceptible to various security threats and attacks, in particular the proliferation of self-propagating malicious codes, also commonly known as “viruses” or “worms”. Once a device in the network becomes compromised, the infection can spread quickly to the remaining devices, causing irreparable harm.

The Bring Your Own Device (BYOD) policy has become widespread among organizations. Under the BYOD policy, employees bring personally owned devices, such as laptops, tablets, smart phones, and the like, to their workplace and use such privately-owned devices to access privileged company information and applications. Under BYOD, the same device is used in different settings—the organizational one and in private settings, such as in the home of the employee.

### BRIEF SUMMARY

One exemplary embodiment of the disclosed subject matter is a computer program product comprising a non-transitory computer readable medium retaining program instructions, wherein said computer program product comprising: a connectivity module configured to determine connectivity of a computer executing the computer program product to a network managed by a server; a port scrambling mode selector configured to select a port scrambling mode based on connectivity determination by said connectivity module, wherein a first mode is selected in response being connected to the network, wherein a second mode is selected in response to being disconnected from the network; a port scrambler configured to compute a second port based on a first port, wherein the port scrambler utilizes a transformation function; an outgoing communication message handler configured to identify an outgoing packet transmitted by a program via the first port and selectively invoke said port scrambler to cause the outgoing packet to be transmitted via the second port, wherein in the first mode, said outgoing communication message handler is configured to invoke said port scrambler in response to the program being listed in a list of authorized programs, whereby, when the computer is connected to the network, outgoing communications issued by authorized programs are sent via scrambled ports and outgoing communications issued by non-authorized programs are sent via original ports; and wherein in the second mode, said outgoing communication message handler is configured to invoke said port scrambler in response to the program not being listed in the list of authorized programs, whereby, when the computer is not connected to the network, outgoing communications issued by authorized programs are sent via original ports and outgoing communications issued by non-authorized programs are sent via scrambled ports.

Optionally, the network comprises a plurality of computers, wherein each of the plurality of computer retains a shared secret parameter that is used by the transformation function in the first mode, wherein each of the plurality of computers is configured to apply an inverse of the transformation function on the second port and using the shared secret parameter, to obtain the first port.

Optionally, the network comprises a plurality of computers, wherein the plurality of computers comprise a first portion and a second portion, wherein the first portion is configured to permanently operate in the first mode, wherein the second portion is configured to operate in the first mode in response to detecting connectivity to the network.

Optionally, the list of authorized programs is received from the server.

Optionally, the network is an organizational network, wherein the list of authorized programs is an implementation of organizational policy, whereby enforcing the organizational policy when the computer is connected to the organizational network in a first manner and enforcing the organizational policy when the computer is connected to another network in a second manner.

Optionally, the computer is a mobile computer configured to be alternately utilized within an organizational network and within a home network, wherein the network is the organizational network, wherein said port scrambling mode selector is configured to select the first mode when the computer is connected to the organizational network, wherein said port scrambling mode selector is configured to select the second mode when the computer is connected to the home network.

Optionally, said port scrambler is configured to apply the transformation function using an encryption key distributed by the server, wherein the encryption key is modified periodically and distributed to devices connected to the network, whereby port scrambling in the first mode is performed using an up-to-date encryption key, whereby port scrambling in the second mode is performed using a potentially out-of-date encryption key.

Optionally, the server is configured to maintain the list and update computers connected to the network.

Optionally, the computer program product may comprise a port descrambler configured to compute a fourth port based on a third port, wherein the port descrambling module utilizes an inverse transformation of the transformation function.

Optionally, the computer program product may comprise an incoming communication message handler configured to identify an incoming packet received via the third port.

Optionally, in the first mode, said incoming communication message handler is configured to invoke said port descrambler to cause the incoming packet to be handled through the third port, whereby, when the computer is connected to the network, incoming communications are received via descrambled ports.

Optionally, wherein in the second mode, said incoming communication message handler is configured to avoid invoking said port descrambler, whereby, when the computer is not connected to the network, incoming communications are received via their original ports.

One exemplary embodiment of the disclosed subject matter is a computer program product comprising a non-transitory computer readable medium retaining program instructions, wherein said computer program product comprising: a connectivity module configured to determine connectivity of a computer executing the computer program product to a network managed by a server; a port scrambling mode selector configured to select a port scrambling mode based on connectivity determination by said connectivity module, wherein a first mode is selected in response being connected to the network, wherein a second mode is selected in response to being disconnected from the network; a port descrambler configured to compute a first port based on a second port, wherein the port descrambler utilizes an inverse transformation of a transformation function, wherein the transformation function is utilized by port scramblers invoked on computers connected to the network; an incoming communication message handler configured to identify an incoming packet received via the second port and selectively invoke said port descrambler, based on the port scrambling mode determined by said port scrambling mode selector, to cause the incoming packet to be handled via the first port, wherein said incoming communication message handler is configured to invoke said port descrambler in the first mode, whereby, when the computer is connected to the network, incoming communications are handled via descrambled ports; and wherein said incoming communication message handler is configured to avoid invocation of said port descrambler in the second mode, whereby, when the computer is disconnected from the network, incoming communications are handler via original ports.

Optionally, a plurality of computers that are connected to the network are configured to scramble ports of authorized communication packets and avoid scrambling ports of unauthorized communication packets, wherein the plurality of computers are configured to scramble ports using the transformation function.

Optionally, the plurality of computers are configured to scramble the ports using the transformation function and based on a list of authorized programs, wherein said port descrambler is configured to utilize the list of authorized program when applying the inverse transformation.

Optionally, the plurality of computers are configured to scramble the ports using the transformation function, based on a list of authorized programs and based on a shared encryption key that is modified periodically, wherein the computer is configured to retrieve the shared encryption key from the network when connected thereto.

Optionally, the server is configured to distribute the shared encryption key to devices connected to the network.

Yet another exemplary embodiment of the disclosed subject matter is a system comprising: a server managing a network; a plurality of devices that are connected to the network, wherein each of the plurality of devices comprise a port scrambling agent, wherein the port scrambling agent is configured to scramble ports of outgoing communications that are transmitted by authorized programs, wherein the port scrambling agent is configured to descramble ports of incoming communications; a computer that is selectively connectable to the network; wherein the computer comprising a mode-based port scrambling agent, wherein the mode-based port scrambling agent is configured to determine a port scrambling mode based on connectivity to the network, wherein said mode-based port scrambling agent is configured to determine a first mode when the computer is connected to the network, wherein said mode-based port scrambling agent is configured to determine a second mode when the computer is disconnected from the network: wherein in the first mode, the mode-based port scrambling agent is configured to: (1) scramble ports of outgoing communications that are transmitted by authorized programs, (2) allow transmission of outgoing communications by unauthorized programs via original ports, and (3) descramble ports of incoming communications; and wherein in the second mode, the mode-based port scrambling agent is configured to: (1) scramble ports of outgoing communications that are transmitted by unauthorized programs; (2) allow transmission of outgoing communications by authorized programs via original ports; and (3) avoid descrambling ports of incoming communications.

Optionally, said mode-based port scrambling agent is configured to determine network connectivity based on connectivity to the server.

Optionally, the server is configured to periodically distribute a shared encryption key to devices connected to the network, wherein said port scrambling agents and mode-based port scrambling agent are configured to utilize the shared encryption key in performing scrambling or descrambling of ports, whereby the mode-based port scrambling agent may not have available thereto an up-to-date shared encryption key when disconnected from the network.

Optionally, the server is configured to distribute a list of authorized programs, whereby organization policy of authorized programs is enforced on mobile devices that are operated when connected to other networks.

Optionally, said port scrambling agents and mode-based port scrambling agent are configured to utilize the list of authorized programs when scrambling or descrambling ports.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a computer network in which the disclosed subject matter is used, in accordance with some exemplary embodiments of the subject matter;

FIG. 1B shows a computer network in which the disclosed subject matter is used, in accordance with some exemplary embodiments of the subject matter;

FIGS. 2A-2C show block diagrams of systems, in accordance with some exemplary embodiments of the disclosed subject matter;

FIG. 3A shows a flowchart diagram of a method, in accordance with some exemplary embodiments of the disclosed subject matter; and

FIG. 3B shows a flowchart diagram of a method, in accordance with some exemplary embodiments of the disclosed subject matter.

### DETAILED DESCRIPTION

One technical problem dealt with by the disclosed subject matter is to provide for secure communication in a computer network.

Another technical problem dealt with by the disclosed subject matter is to prevent spreading of malicious code within a computer network.

Yet another technical problem dealt with by the disclosed subject matter is to provide a security measurement for BYOD devices that is applicable in both the organizational setting and the home setting.

Yet another technical problem dealt with by the disclosed subject matter is to enable to use of a device implementing port scrambling in a synchronized manner, when disconnected from the network. In U.S. Pat. No. 9,838,368, entitled “PORT SCRAMBLING FOR COMPUTER NETWORKS”, filed Aug. 25, 2016, which is hereby incorporated by reference in its entirety for all purposes without giving rise to disavowment, a method, system and product for providing secure communications through the use of port scrambling was disclosed. Such secure communication is implemented by selectively scrambling the ports of outgoing communications, if such communications are authorized, and descrambling the ports of all incoming communications. As a result, only devices that utilize the same scrambling method and encryption keys used for scrambling are able to effectively communicate with one another. However, a same device may be connected to different networks at different times. If such device continues to employ the above scrambling scheme in an environment where no other device utilizes it, the device may not be able to communicate with other devices. Yet, it may be desired to still provide the protection layer for the device, to reduce the risk of the device being infected. It is noted that as far as Applicant is aware the selective port scrambling technique is a matter of public knowledge in view of the previous disclosure, but has not yet become widely spread, routine or conventional.

A “port” is a logical construct associated with a service or process residing on a computing platform and serves as an endpoint for different types of network communication. In some exemplary embodiments, a port is identified for each host address and communication protocol by a 16-bit number, thus a port number ranges from 0 to 65535. Generally, port numbers appear in network packets and map to specific processes or resources on the destination device that can handle or are expecting those packets. Some resources are preconfigured to listen to only certain predefined port numbers and ignore traffic associated with other ports. Typical network protocols that heavily rely on port numbers to map to resources include Transmission Control Protocol (TCP) and User Datagram Protocol (UDP). Some port numbers or port number ranges may be reserved for standard services, such as the “well-known ports” ranging from 0 to 1023 used by TCP and UDP. For example, services running the Hypertext Transfer Protocol (HTTP) protocol typically listen on port 80.

One technical solution is to provide a scrambling mechanism whose operation depends on connectivity of the computer to a network. In some exemplary embodiments, when the computer is connected to the network, scrambling is performed for outgoing communications that are authorized (e.g., transmitted by authorized programs that appear in a whitelist). When the computer is not connected to the network where the synchronized scrambling is performed, outgoing communications are scrambled only for unauthorized communications. Hence, a communication message issued an authorized program, such as MICROSOFT OUTLOOK™, may be transmitted in a scrambled port, if the computer is connected to the network, and transmitted in its original port, if the computer is disconnected from the network (or connected to another network). In some exemplary embodiments, incoming messages are handled in a manner that depends on the connectivity to the network: ports of incoming messages are descrambled when connected to a network where the devices scramble authorized communications, and in case the computer is not connected to such network, no descrambling is performed for incoming, messages.

One technical effect of utilizing the disclosed subject matter is to allow detection of attacks or outbreaks within the network by identifying access attempts at regular port numbers. Furthermore, attempts to access ports that are not a scrambled version of any useful ports may also be indicative of potential unauthorized activity as authorized activity is constrained to be directed solely at scrambled ports.

Another technical effect is to prevent outspread of malicious activity that relies on human engineering in the network. Even in case a human user is manipulated to allow access to a malicious user or code (e.g., pressing a harmful link or executing a malware sent via e-mail), malicious activity is likely to be contained in the infected device and not be spread to other devices.

Yet another technical effect is providing a cyber security protection measurement for BYOD devices and other devices that are not permanently connected to the organizational network and which sometimes connect to other networks. The disclosed subject matter enables the devices to continue working, even when a port scrambling agent is operating on them. The devices are provided with a firewall-like security layer using the same software, without requiring additional software to be installed or executed.

In some exemplary embodiments, the security layer may be provided while applying the policy defined by their organization when outside the organizational network. In some cases, an alternative policy may be defined as a modification of the organizational policy, such as by preventing usage of some authorized programs that are internal to the organization, or by allowing usage of commonly used programs that are prohibited when in the organization. In some other cases, different policies may be implemented and used for different connectivity statuses (e.g., different policy for home usage, for organizational usage, for usage in airport networks, or the like).

It will be appreciated that the disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

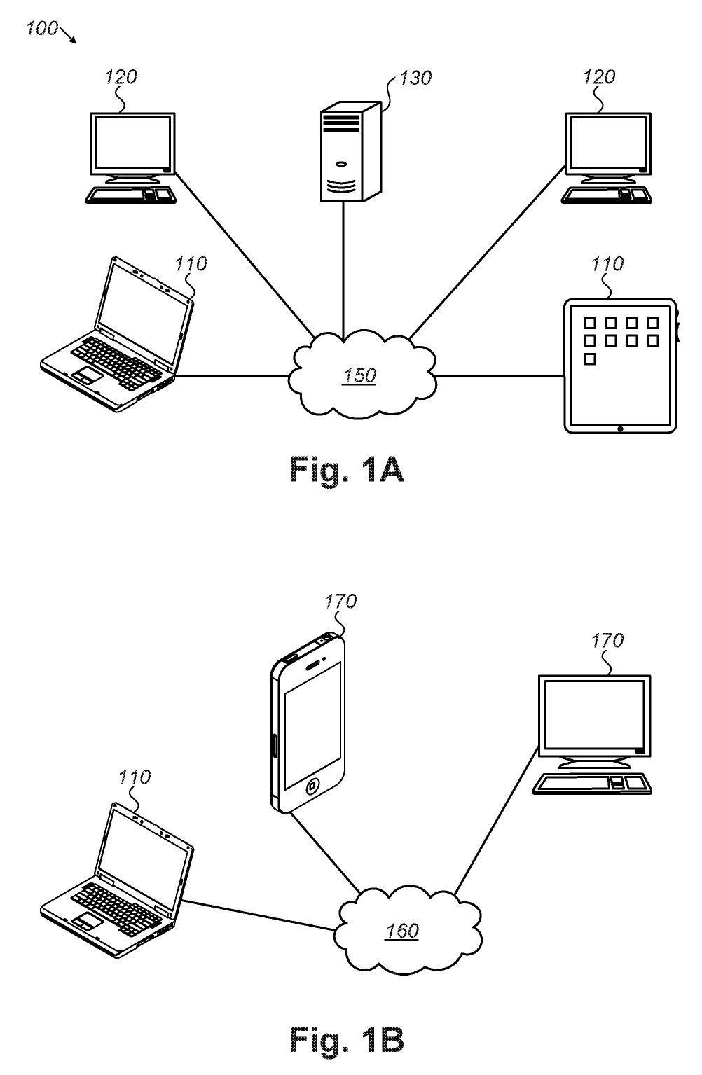

Referring now to FIG. 1A showing a computer network in which the disclosed subject matter is used, in accordance with some exemplary embodiments of the subject matter.

In some exemplary embodiments, a Computer Environment 100 may comprise a plurality of computing devices, such as 110. 120, 130 that are connected via a Network 150. Devices 110, 120, 130 may be interconnected to one another, either by common access to a server (e.g., Server 130) or directly, such as through using a network switch, a hub, or the like.

In some exemplary embodiments, Network 150 may be an intranet network of an organization. Network 150 may be connected to an external network, such as the Internet (not shown). In some cases, Network 150 is connected to the external network by a router, switch, server or the like, which may or may not be configured to provide some security measures to prevent malicious activity. In one embodiment, the switch comprises a firewall that prevents access of undesired entities.

Computers 110, such as a laptop computer, a tablet computer, a smartphone, or the like, may be devices that are connected to Network 150 temporarily. For example, Computer 110 may be a BYOD device of an employee and connected to Network 150 at the beginning of the work day and removed therefrom at the end of the workday. Additionally, or alternatively, Computer 110 may be a computer owned by the organization and intended to be used in the organization and outside of the organization, such as in the field.

Computers 120 may be stationary and generally statically and permanently connected to Network 150. For example, Computer 120 may be a desktop workstation located within the premises of the organization and not intended to being disconnected and used elsewhere.

Server 130 may be a computerized server tasked with monitoring and protecting the security of Network 150. In some exemplary embodiments, IT professional may define an organizational policy, such as defining a whitelist of authorized programs, authorized uses of programs, a blacklist of unauthorized programs, or the like. Additionally, or alternatively, the policy may be automatically defined. Sever 130 may publish and distribute the policy to computers connected to Network 150. Additionally, or alternatively, Server 130 may publish and update an encryption key to be used for security-related operation. The encryption key may be modified periodically, such as every about one second, about one minute, about one hour, or the like.

In some exemplary embodiments, computers connected to Network 150 may be configured to communicate using scrambled ports. Authorized outgoing communications, such as packets issued by authorized programs or under authorized conditions, may be handled and their port may be scrambled, such as using a transformation function. The transformation function may utilize shared parameters such as the whitelist, encryption key, or the like, so as to achieve the same results on different computers. As the encryption key may change periodically, the transformation function may yield different results for the same port at different times. The ports of unauthorized communications may not be scrambled, and they may be transmitted via the original port. Additionally, or alternatively, the content of the packets may be encrypted. In some exemplary embodiments, computers connected to Network 150 may be configured to descramble the ports of any incoming communication, using an inverse function of the transformation function. Hence, the ports of authorized communications may be scrambled at transmission and descrambled at reception, yielding the original port, while the ports of unauthorized communications are only descrambled at receptions, and therefore received at a wrong port on the receiving end. In some exemplary embodiments, scrambling and descrambling may be performed by a port scrambling agent, which may be implemented in software, hardware, combination thereof, or the like.

In some exemplary embodiments, communications in an organization's network may go through a firewall. The firewall may not be configured to handle port scrambling/descrambling. In such case, the port scrambling agent may determine that the packet is directly transmitted to a firewall and avoid port scrambling of such packet. Additionally, or alternatively, a receiving device receiving a packet directly from a firewall, may avoid performing port descrambling on the received packet.

In some exemplary embodiments, the port scrambling agent may be configured to avoid scrambling when transmitting packets towards specific devices, such as sending packets towards an Voice Over IP (VoIP) telephone, a printer, a network-connected time clock, or other devices which utilize the network connection but for which an agent is not installed. Additionally, or alternatively, the port scrambling agent may be configured to avoid descrambling ports of packets received from such devices.

Additionally, or alternatively, as such simple devices may not be configured to execute an agent (e.g., as they may not support execution of third-party programs, may not include an Operating System, or the like), a hardware agent may be connected to the device via wired connection. The hardware agent may process incoming sent to the device and outgoing messages sent from the device and provide the port scrambling and descrambling capabilities. The hardware agent may process incoming messages, descramble the ports and transmit the modified communication, with the descrambled port, to the device. Additionally, or alternatively, communications transmitted by the device may be processed by the hardware agent and their ports may be selectively scrambled, if they match the organizational policy.

However, Computer 110 may be removed from Network 150 and connected to other networks, such as Network 160 of FIG. 1B, where Devices 170 are connected. As an example, Network 160 may be a public Wi-Fi network, a home LAN network, a wired LAN network at a hotel or conference center, or the like. As Device 170 may not utilize port scrambling agents, if Computer 110 would scramble the ports of incoming and outgoing communications, Computer 110 may not be able to communicate with the devices connected to Network 160. In addition, as Computer 110 may not have access to Server 130 and may not be able to receive the periodically modifiable encryption key, while being connected to Network 160 and disconnected from Network 150.

In some exemplary embodiments, the port scrambling agent of Computer 110 may detect that Computer 110 is not connected to Network 150, such as for example, based on detection of lack of connectivity to Server 130, and change its operation mode. Instead of scrambling ports of all authorized outgoing messages and descrambling ports of all incoming messages, the port scrambling agent may scramble the ports of unauthorized outgoing communications only. The port scrambling agent may rely on the fact that other devices do not descramble ports of incoming messages, and hence outgoing communications whose ports are scrambled may be received at unintended ports and disregarded by the receiving end.

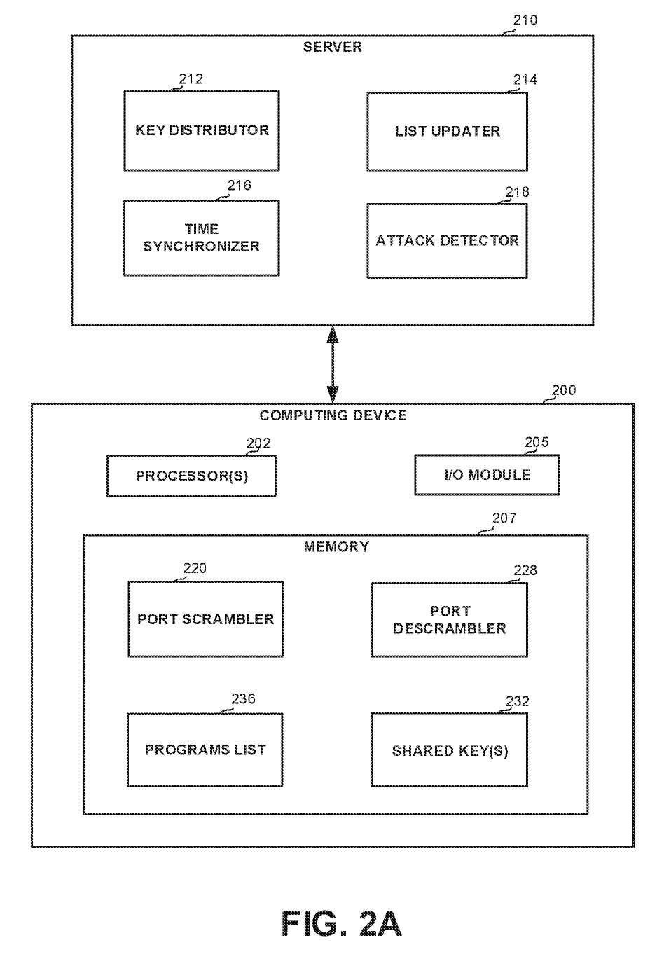

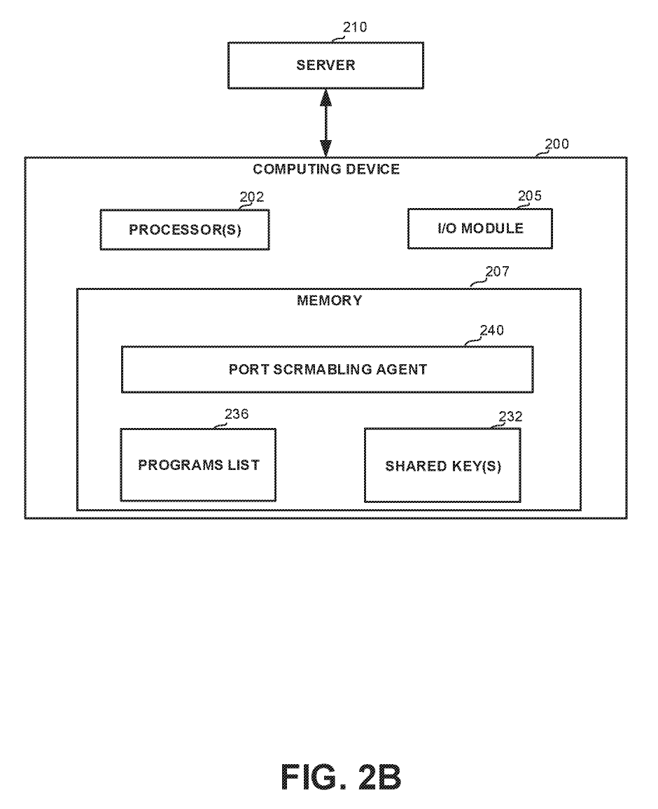

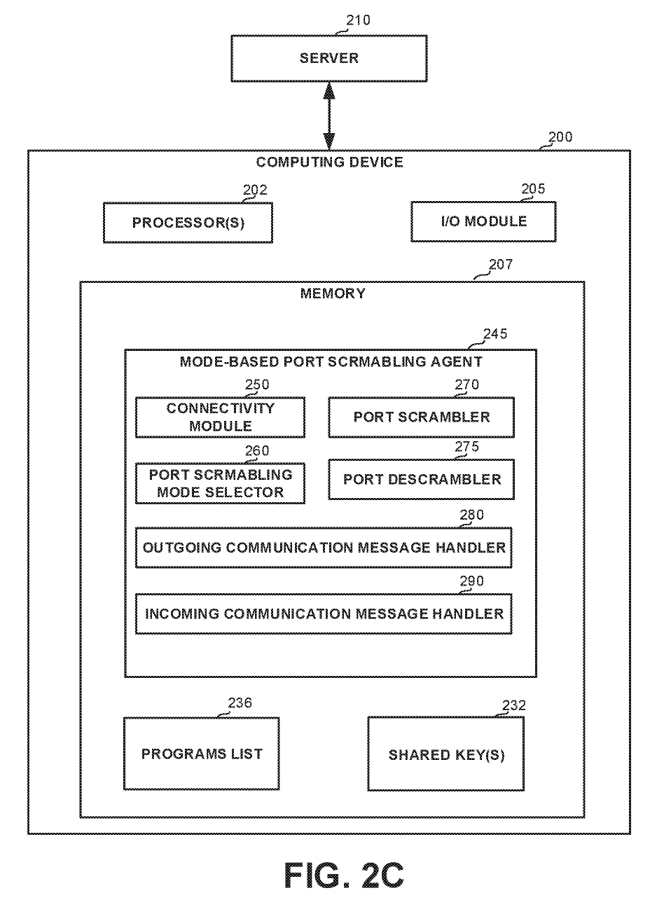

Referring now to FIG. 2A showing a block diagram of a system in accordance with some exemplary embodiments of the disclosed subject matter. The system comprises a Computing Device 200, such as 110, 120 of FIG. 1A, and may be configured to perform selective port scrambling, in accordance with the disclosed subject matter. In some exemplary embodiments, the system further comprises a Server 210, such as Server 130 of FIG. 1A, which may be in communication with Computing Device 200 via any suitable communication channel, such as an Ethernet switch connection or the like.

In some exemplary embodiments, Computing Device 200 may comprise one or more Processor(s) 202. Processor 202 may be a Central Processing Unit (CPU). a microprocessor, an electronic circuit, an Integrated Circuit (IC) or the like. Processor 202 may be utilized to perform computations required by Computing Device 200 or any of its subcomponents.

In some exemplary embodiments of the disclosed subject matter, Computing Device 200 may comprise an Input/Output (I/O) Module 205. The I/O Module 205 may be utilized to provide an output to and receive input from a user. Additionally, or Alternatively, I/O Module 205 may be utilized to provide output to and receive input from Server 210 or another Computing Device 200 in communication therewith, such as another one of Devices 110, 120 of FIG. 1A.

In some exemplary embodiments, Computing Device 200 may comprise a Memory 207. Memory 207 may be a hard disk drive, a Flash disk, a Random-Access Memory (RAM), a memory chip, or the like. In some exemplary embodiments, Memory 207 may retain program code operative to cause Processor 202 to perform acts associated with any of the subcomponents of Computing Device 200.

Memory 207 may comprise one or more components as detailed below, implemented as executables, libraries, static libraries, functions, or any other executable components.

Memory 207 may comprise Port Scrambler 220 which may comprise or be in communication with a Programs List 236 and one or more Shared Key(s) 232. Port Scrambler 220 may be configured to selectively apply a port scrambling function on port numbers associated with outgoing communications. Port Scrambler 220 may apply the port scrambling function responsive to receiving a request to transmit an outgoing communication from an application program listed on Programs List 236 (and executed by Computing Device 200). Port Scrambler 220 may use Shared Key(s) 232 as a parameter of the port scrambling function. Port Scrambler 220 may obtain a scrambled port number by applying the port scrambling function on the port number identifying the destination of the outgoing communication. Port Scrambler 220 may direct the outgoing communication to a destination identified by the scrambled port number.

Memory 207 may comprise Port Descrambler 228 which may comprise or be in communication with Shared Key(s) 232. Port Descrambler 228 may be configured to apply a port descrambling function on port numbers associated with incoming communications to Computing Device 200. The port descrambling function may be an inverse function of the port scrambling function applied by Port Scrambler 220. Port Descrambler 228 may use Shared Key(s) 232 as a parameter of the port descrambling function. Port Descrambler 228 may receive an incoming communication at a port identified by a scrambled port number. Port Descrambler 228 may obtain a descrambled port number (e.g., original port number) by applying the port descrambling function on the scrambled port number. In some exemplary embodiments, Port Descrambler 228 may perform the descrambling on all incoming communications regardless of their origin. Port Descrambler 228 may redirect the incoming communication to a port identified by the descrambled port number. Port Descrambler 228 may issue a notification to Server 210 in case that the descrambled port number is not assigned to any application program currently executing on Computing Device 200.

Similarly to Computing Device 200, Server 210 may comprise Processor(s) (not shown), I/O Module (not shown) and Memory (not shown).

Server 210 may comprise a Key Distributor 212 for generating and distributing

Shared Key(s) 232 among a plurality of computing devices, such as Computing Device 200, in a computer network environment such as Computer Environment 100 of FIG. 1A. Key Distributor 212 may distribute Shared Key 232 to Computing Device 200 using Public Key Infrastructure (PKI) cryptography. Shared Key 232 may comprise a fixed encryption key. Additionally or alternatively, Shared Key 232 may comprise a time-dependent encryption key, replaced periodically and valid for a limited time duration. In some exemplary embodiments, Shard Key(s) 232 may comprise three keys: a time dependent key that is updated periodically, a fixed key that uniquely identifies the organization in which the system of FIG. 2 is deployed, and a key which depends on Programs List 236, such as a hashing of Programs List 236.

Server 210 may comprise a List Updater 214 for maintaining and updating Programs List 236 among the plurality of computing devices in the network environment. List Updater 214 may provide credentials enabling verification of the content of Programs List 236 by Computing Device 200, for example by applying a hash function on Programs List 236 and digitally signing the result. The credentials may also be used for the scrambling or descrambling process, as one of the Shared Key(s) 232, that is distributed by Key Distributor 212.

Server 210 may comprise a Time Synchronizer 216 for synchronizing system clocks among the plurality of computing devices in the network environment, in case that one or more of the Shared Key(s) 232 distributed by Key Distributor 212 are time-dependent.

Server 210 may comprise an Attack Detector 218, configured for tracking and analyzing traffic in the computer network environment in order to detect possible security attacks and outbreaks. Attack Detector 218 may receive and analyze notifications from Computing Device 200 concerning incoming communications for which the descrambled port number is not assigned to an application program.

In some exemplary embodiments, Key Distributor 212, List Updater 214, Time Synchronizer 216 and Attack Detector 218 may be deployed on one or more separate servers. In one embodiment, each of the above is deployed on a stand-alone and separate server.

In some exemplary embodiments, Server 210 may monitor communication in the network, identify transmission to invalid ports, analyze such transmission to detect potential malicious activity and mitigate risk from such activities. In some exemplary embodiments, the disclosed subject matter may utilize a server such as disclosed in U.S. Pat. No. 9,794,277, entitled “MONITORING TRAFFIC IN A COMPUTER NETWORK”, filed Dec. 27, 2016, which is hereby incorporated by reference in its entirety for all purposes without giving rise to disavowment.

FIG. 2B shows a block diagram of a system in accordance with some exemplary embodiments of the disclosed subject matter. Computing Device 200 may be a device that is intended to continuously and permanently be connected to Network 150, such as devices that are intended to remain in the premises of the organization. It is noted that the device may be removed from the premises from time to time, such as for technical support, upgrading, or the like. However, the device may not be intended to be taken as is and used in other networks, such as may be the case in BYOD devices, laptops, or the like.

Port Scrambling Agent 240 may be configured to scramble and descramble ports of incoming and outgoing communications, in accordance with the disclosed subject matter, such as using Port Scrambler 220 and Port Descrambler 228 of FIG. 2A.

FIG. 2C exemplifies a Computing Device 200 which is intended to be used in other networks as well as the organizational network, Network 150. For example, Computing Device 200 of FIG. 2C may be Computer 110 which may at times be connected to the organizational network (e.g. 150 of FIG. 1A) and at other times connected to other networks (e.g. 160 of FIG. 1B).

Mode-Based Port Scrambling Agent 245 may be configured to provide the functionality of Port Scrambling Agent 240 in one mode of operation and other functionalities in other modes of operation.

In some exemplary embodiments, Connectivity Module 250 may be configured to determine connectivity of Computing Device 200 to the network where port scrambling is implemented (e.g., 150 of FIG. 1A). In some exemplary embodiments, connectivity may be determined based on connectivity to the Server 210. For example, if Server 210, which is configured to distribute the keys (e.g., Key Distributer 212) is not reachable, Computing Device 200 may determine that it does not operate within the organizational network, and that other devices in the network do not descramble ports of incoming communications and do not scramble ports of authorized communications.

Port Scrambling Mode Selector 260 may be configured to select port scrambling mode based on the connectivity determined by Connectivity Module 250. In case the Computing Device 200 is connected to the network, a first mode, also referred to as authorized scrambling mode, is selected. Otherwise, a second mode, also referred to as prohibited scrambling mode, is selected.

In some exemplary embodiments, under the authorized scrambling mode, ports of all incoming communications are descrambled and ports of authorized communications are descrambled. Under such mode, it may be assumed that other devices utilize the same mode, or that they employ a port scrambling agent that only operates in the authorized scrambling mode, such as Port Scrambling Agent 240 of FIG. 2B.

In some exemplary embodiments, under the prohibited scrambling mode, ports of incoming communications may not be modified and incoming messages may be handled via their original ports. Additionally, or alternatively, outgoing communications may be scrambled only if they are determined to be prohibited. Authorized communications, such as communications adhering to the defined policy, communications issued by authorized programs (e.g., listed in the whitelist or not listed in the blacklist), may be transmitted without port manipulation. Ports of outgoing unauthorized communications may be scrambled to ensure that they are not received at their intended port on the receiving end.

Port Scrambler 270 may be configured to scramble ports, such as using a transformation function. Port Descrambler 275 may be configured to descramble ports, such as using an inverse transformation of the transformation function. Port Scrambler 270 and Port Descrambler 275 may be similar to 220 and 228, respectively.

In some exemplary embodiments, Outgoing Communication Message Handler 280 may be configured to invoke Port Scrambler 270 when scrambling of the ports of outgoing messages is desired. In some exemplary embodiments, in the authorized scrambling mode, Outgoing Communication Message Handler 280 may be configured to invoke Port Scrambler 270 only for outgoing communications that are deemed authorized. Additionally, or alternatively, in the prohibited scrambling mode, Outgoing Communication Message Handler 280 may be configured to invoke Port Scrambler 270 only for outgoing communications that are deemed unauthorized.

In some exemplary embodiments, Incoming Communication Message Handler 290 may be configured to invoke Port Descrambler 275 when descrambling of the ports of incoming messages is desired. In some exemplary embodiments, in the authorized scrambling mode, Incoming Communication Message Handler 290 may be configured to invoke Port Descrambler 275 for all incoming communications received by Computing Device 200. Additionally, or alternatively, in the prohibited scrambling mode, Incoming Communication Message Handler 290 may be configured to avoid invoking Port Descrambler 275, and allow all incoming messages to be handled via their designated, original, port.

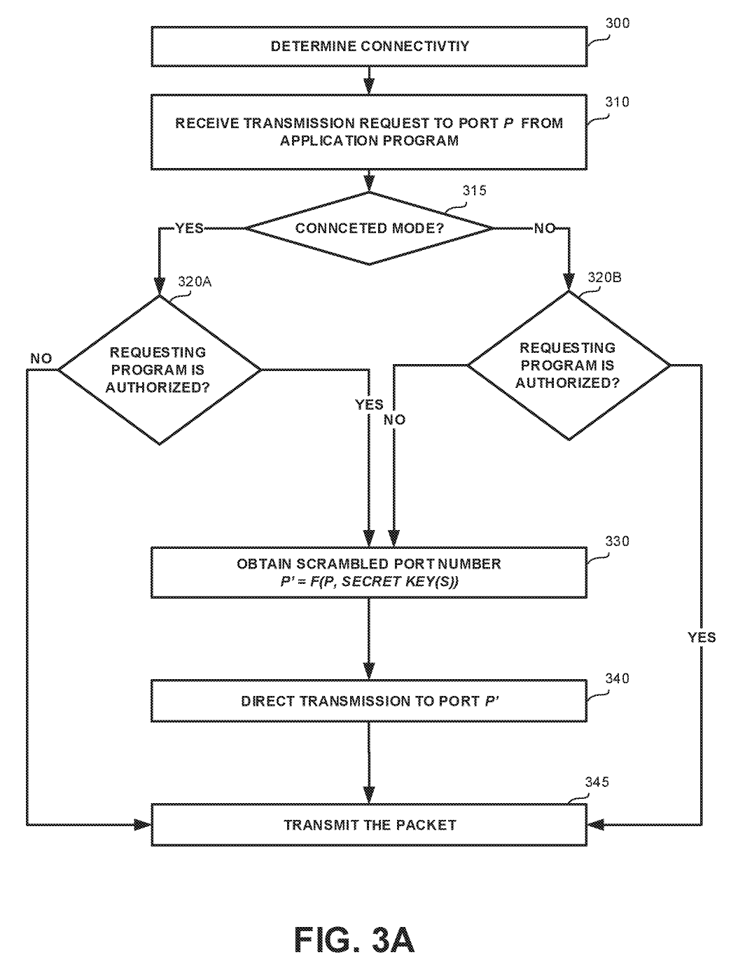

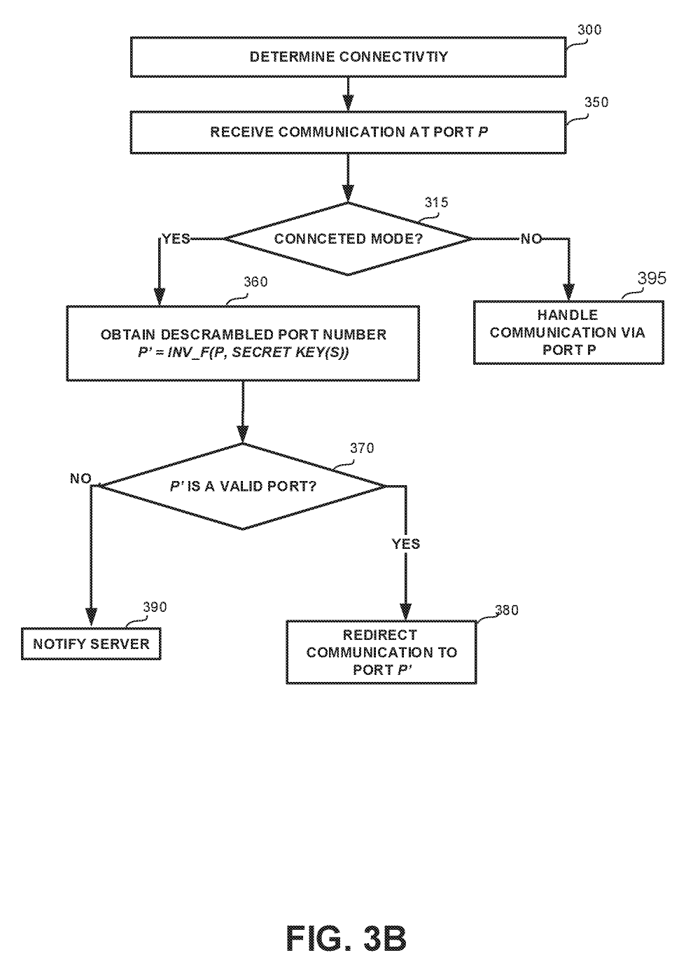

Referring now to FIG. 3A showing a flowchart diagram of a method in accordance with some exemplary embodiments of the disclosed subject matter.

On Step 300, connectivity to the protected network may be determined. In some exemplary embodiments, connectivity may be determined based on whether the device is connected directly to the network, connected to a router, hub, or a similar networking device, of the network, or the like. Additionally, or alternatively, connectivity may be determined based on whether the device is connectable to a server distributing the shared encryption keys used by the port scrambling agents, such as 130 of FIG. 1A.

On Step 310, a request of an application program to transmit an outgoing communication may be received. The application program may be executed by a computerized apparatus, such as Computing Device 200 of FIGS. 2A-2C. The outgoing communication may be designated to be received at a destination via a first port (denoted “P”). The destination may be a destination external to the computerized apparatus, e.g. another Computing Device 200. As an example, the destination of a UDP packet may be provided as an IP address and a port (e.g., 192.168.1.52:80).

On Step 315, a mode of operation may be determined based on the connectivity determination (300). In case the device is connected to a protected network, Step 320A may be performed. If the device is not connected to a protected network, Step 320B may be performed.

On Step 320A, a determination whether the requesting application program is authorized may be made. The determination may be accomplished by consulting a list of authorized programs, such as Programs List 236 of FIG. 2A, by consulting a blacklist of unauthorized programs, or the like. In some exemplary embodiments, non-authorized programs may still operate in the computing device, however, in view of the disclosed subject matter, such programs may not be able to effectively communicate with other devices on the same network. Additionally, or alternatively, the determination may be whether the outgoing communication is authorized, such as based on the identity of the transmitting program, a chain of invocations, such as disclosed in U.S. patent application Ser. No. 15/464,403, entitled PREVENTING UNAUTHORIZED OUTGOING COMMUNICATIONS, filed on Mar. 31 2017. which is hereby incorporated by reference in its entirety without giving rise to disavowment, based on matching a template defining authorized structure and content of packets, or the like.

On Step 330, a transformation function may be applied on an identifier of the first port to obtain an identifier of a second port. The transformation function may depend on at least one secret parameter shared among a plurality of computing devices in a computer network, such as Shared Key 232 of FIG. 2A. The identifier of the first port may be obtainable by applying an inverse transformation on the identifier of the second port. The inverse transformation may depend on the at least one secret parameter, such that only devices sharing the at least one secret parameter may be able to apply the inverse transformation. The transformation function may be either a symmetric cryptography function, such as DES, AES, or the like, or an asymmetric cryptography function, such as RSA, E1-Gammal, or the like.

In some exemplary embodiments, the scrambled port number may not be a port number which has a general known functionality, such as port numbers known as “common port numbers” which are published by the Internet Assigned Number Authority (IANA) or the like. As an example, the scrambled port may not be port 20-21 (used for FTP), port 22 (used for SSH), port 53 (used for DNS), port 80 (used for HTTP), port 443 (used for HTTPS) or the like. On Step 330, in case the transformation function provides an excluded port, a next non-excluded port may be selected. Additionally, or alternatively, a list of excluded ports may include common port numbers or other port numbers which are constantly excluded. The list may also include port numbers which were used as scrambled ports in a previous time segment. For example, in case port 80 was scrambled to port 1579 during a first time segment, in a next time segment, when port 80 is scrambled to a different port number, all other ports may be excluded from being scrambled to port 1579 so as to avoid collision and confusion. In such an embodiment, a packet that is destined to port 1579 and is received in the second segment may be uniquely identified as a packet that was transmitted during the first time segment towards port 80.

On Step 340, the outgoing communication may be directed to be transmitted via the second port. In the above given example in which the original address is 192.168.1.52:80 and in which port 80 is scrambled to port 1579, the outgoing communication may be transmitted to 192.168.1.52:1579.

On Step 345, the outgoing communication may be transmitted, either via the original port P or the scrambled port P′, depending on whether the port was scrambled or not.

On Step 320B, a determination whether the requesting application program is authorized may be made, similarly to determination made in Step 320A. However, only if the communication is not deemed authorized, e.g., transmitted by an unauthorized program, the port is scrambled (330) and the communication is transmitted via the scrambled port (340-345). Otherwise, in case the communication is deemed authorized (e.g., transmitted by a whitelisted program, not transmitted by a blacklisted program, adhering to predetermined rules regarding chain of program invocations, adhering to predetermined rules regarding packet content and structure, or the like), the packet is transmitted as is without modifying the port (345).

In some exemplary embodiments, a content of the at least one secret parameter may be updated in each of the plurality of computing devices in the network. As a result, operation of the transformation function may be dynamically and automatically modified for all computing devices in the network. In particular, a subsequent request to transmit an outgoing communication to be received via the first port, may result in the application of the transformation function on Step 330 yielding an identifier of a third port different from the second port. In some exemplary embodiments, the transformation function is modified without a user providing a modified definition thereof.

Referring now to FIG. 3B showing a flowchart diagram of a method in accordance with some exemplary embodiments of the disclosed subject matter.

On Step 350, an incoming communication via a first port of a computerized apparatus, such as Computing Device 200 of FIGS. 2A-2C, may be received. The incoming communication may be received from an external device via a computer network, such as Network 150.

On Step 315, based on the connectivity, a mode of operation may be determined. In case of a connected mode, Steps 360-390 may be performed. In such steps, the port of the incoming message may be descrambled and the communication may be handled based on the validity of the descrambled port. In case the device is not connected to a protected network, Step 395 may be performed. In such step, the message is handled as is without descrambling its port.

On Step 360, an identifier of a second port may be obtained by applying an inverse transformation function on an identifier of the first port. The inverse transformation function may depend on at least one secret parameter shared among a plurality of computing devices in the computer network, such as Shared Key 232 of FIG. 2A.

On Step 370, a determination whether the second port is a valid port may be made. A valid port may be any port that is used by any of the programs in a list of authorized programs, such as Programs List 236 of FIG. 2A. Additionally, or alternatively, a valid port may be any common port. Additionally, or alternatively, a valid port may be any port that is used by a program that is executed by the computerized apparatus.

On Step 380, in case that the second port was determined to be a valid port on Step 370, the incoming communication may be redirected to the second port. In some exemplary embodiments, subsequently, the incoming communication is received by a program and handled appropriately.

On Step 390, in case that the second port was determined as not being a valid port on Step 370, a corresponding notification may be issued to an entity in charge of tracking and analyzing network traffic for detecting attacks, such as Attack Detector 218 at Server 210 of FIG. 2. Additionally, or alternatively, the received communication may be dropped and disregarded.

In some exemplary embodiments, in the authorized scrambling mode, a communication issued by an application that is not part of the list of authorized programs, such as Programs List 236 of FIG. 2A, is not scrambled as described in FIG. 3A and thus is not received and handled by the desired final destination at the receiving device, as depicted in FIG. 3B. As a result, any non-authorized program that is executed by a device on the network is unable to effectively communicate with other devices.

In some exemplary embodiments, in the authorized scrambling mode, an unauthorized application is incapable of effectively accessing an external network to report to a malicious user. In order to communicate with a device in the external network, the device first needs to communicate with a router, bridge, switch or a similar device referred to as a router, which connects the network to the external network. Such communication may also be performed based on scrambled ports. As a result, and as the communication initiated by the unauthorized application is not scrambled, the router dismisses the communication and does not act upon it.

On Step 395, the received communication may be handled via its original port, P. The port may not be descrambled, and the original port may be used as the receiving port through which the communication message is processed.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A computer program product comprising a non-transitory computer readable medium retaining program instructions, wherein said computer program product comprising:
a connectivity module configured to determine connectivity of a computer executing the computer program product to a network managed by a server;
a port scrambling mode selector configured to select a port scrambling mode based on connectivity determination by said connectivity module, wherein a first mode is selected in response being connected to the network, wherein a second mode is selected in response to being disconnected from the network;
a port scrambler configured to compute a second port based on a first port, wherein the port scrambler utilizes a transformation function;
an outgoing communication message handler configured to identify an outgoing packet transmitted by a program via the first port and selectively invoke said port scrambler to cause the outgoing packet to be transmitted via the second port,
wherein in the first mode, said outgoing communication message handler is configured to invoke said port scrambler in response to the program being listed in a list of authorized programs, whereby, when the computer is connected to the network, outgoing communications issued by authorized programs are sent via scrambled ports and outgoing communications issued by non-authorized programs are sent via original ports; and
wherein in the second mode, said outgoing communication message handler is configured to invoke said port scrambler in response to the program not being listed in the list of authorized programs, whereby. when the computer is not connected to the network, outgoing communications issued by authorized programs are sent via original ports and outgoing communications issued by non-authorized programs are sent via scrambled ports.

2. The computer program product of claim 1, wherein the network comprises a plurality of computers, wherein each of the plurality of computer retains a shared secret parameter that is used by the transformation function in the first mode, wherein each of the plurality of computers is configured to apply an inverse of the transformation function on the second port and using the shared secret parameter, to obtain the first port.

3. The computer program product of claim 1, wherein the network comprises a plurality of computers, wherein the plurality of computers comprise a first portion and a second portion, wherein the first portion is configured to permanently operate in the first mode, wherein the second portion is configured to operate in the first mode in response to detecting connectivity to the network.

4. The computer program product of claim 1, wherein the list of authorized programs is received from the server.

5. The computer program product of claim 1, wherein the network is an organizational network, wherein the list of authorized programs is an implementation of organizational policy, whereby enforcing the organizational policy when the computer is connected to the organizational network in a first manner and enforcing the organizational policy when the computer is connected to another network in a second manner.

6. The computer program product of claim 1, wherein the computer is a mobile computer configured to be alternately utilized within an organizational network and within a home network, wherein the network is the organizational network, wherein said port scrambling mode selector is configured to select the first mode when the computer is connected to the organizational network, wherein said port scrambling mode selector is configured to select the second mode when the computer is connected to the home network.

7. The computer program product of claim 1, wherein said port scrambler is configured to apply the transformation function using an encryption key distributed by the server, wherein the encryption key is modified periodically and distributed to devices connected to the network, whereby port scrambling in the first mode is performed using an up-to-date encryption key, whereby port scrambling in the second mode is performed using a potentially out-of-date encryption key.

8. The computer program product of claim 1, wherein the server is configured to maintain the list and update computers connected to the network.

9. The computer program product of claim 1, further comprising:
a port descrambler configured to compute a fourth port based on a third port, wherein the port descrambling module utilizes an inverse transformation of the transformation function;
an incoming communication message handler configured to identify an incoming packet received via the third port,
wherein in the first mode, said incoming communication message handler is configured to invoke said port descrambler to cause the incoming packet to be handled through the third port, whereby, when the computer is connected to the network, incoming communications are received via descrambled ports; and
wherein in the second mode, said incoming communication message handler is configured to avoid invoking said port descrambler, whereby, when the computer is not connected to the network, incoming communications are received via their original ports.

10. A computer program product comprising a non-transitory computer readable medium retaining program instructions, wherein said computer program product comprising:
a connectivity module configured to determine connectivity of a computer executing the computer program product to a network managed by a server;
a port scrambling mode selector configured to select a port scrambling mode based on connectivity determination by said connectivity module, wherein a first mode is selected in response being connected to the network, wherein a second mode is selected in response to being disconnected from the network;
a port descrambler configured to compute a first port based on a second port, wherein the port descrambler utilizes an inverse transformation of a transformation function, wherein the transformation function is utilized by port scramblers invoked on computers connected to the network;
an incoming communication message handler configured to identify an incoming packet received via the second port and selectively invoke said port descrambler, based on the port scrambling mode determined by said port scrambling mode selector, to cause the incoming packet to be handled via the first port,
wherein said incoming communication message handler is configured to invoke said port descrambler in the first mode, whereby, when the computer is connected to the network, incoming communications are handled via descrambled ports; and
wherein said incoming communication message handler is configured to avoid invocation of said port descrambler in the second mode, whereby, when the computer is disconnected from the network, incoming communications are handler via original ports.

11. The computer program product of claim 10, wherein a plurality of computers that are connected to the network are configured to scramble ports of authorized communication packets and avoid scrambling ports of unauthorized communication packets, wherein the plurality of computers are configured to scramble ports using the transformation function.

12. The computer program product of claim 11, wherein the plurality of computers are configured to scramble the ports using the transformation function and based on a list of authorized programs, wherein said port descrambler is configured to utilize the list of authorized program when applying the inverse transformation.

13. The computer program product of claim 11, wherein the plurality of computers are configured to scramble the ports using the transformation function, based on a list of authorized programs and based on a shared encryption key that is modified periodically, wherein the computer is configured to retrieve the shared encryption key from the network when connected thereto.

14. The computer program product of claim 13, wherein the server is configured to distribute the shared encryption key to devices connected to the network.

15. A system comprising:
a server managing a network;
a plurality of devices that are connected to the network, wherein each of the plurality of devices comprise a port scrambling agent, wherein the port scrambling agent is configured to scramble ports of outgoing communications that are transmitted by authorized programs, wherein the port scrambling agent is configured to descramble ports of incoming communications;
a computer that is selectively connectable to the network;
wherein the computer comprising a mode-based port scrambling agent, wherein the mode-based port scrambling agent is configured to determine a port scrambling mode based on connectivity to the network, wherein said mode-based port scrambling agent is configured to determine a first mode when the computer is connected to the network, wherein said mode-based port scrambling agent is configured to determine a second mode when the computer is disconnected from the network;
wherein in the first mode, the mode-based port scrambling agent is configured to:
scramble ports of outgoing communications that are transmitted by authorized programs,
allow transmission of outgoing communications by unauthorized programs via original ports, and
descramble ports of incoming communications; and
wherein in the second mode, the mode-based port scrambling agent is configured to:
scramble ports of outgoing communications that are transmitted by unauthorized programs;
allow transmission of outgoing communications by authorized programs via original ports; and
avoid descrambling ports of incoming communications.

16. The system of claim 15, wherein said mode-based port scrambling agent is configured to determine network connectivity based on connectivity to the server.

17. The system of claim 15, wherein the server is configured to periodically distribute a shared encryption key to devices connected to the network, wherein said port scrambling agents and mode-based port scrambling agent are configured to utilize the shared encryption key in performing scrambling or descrambling of ports, whereby the mode-based port scrambling agent may not have available thereto an up-to-date shared encryption key when disconnected from the network.

18. The system of claim 15, wherein the server is configured to distribute a list of authorized programs, whereby organization policy of authorized programs is enforced on mobile devices that are operated when connected to other networks.

19. The system of claim 18, wherein said port scrambling agents and mode-based port scrambling agent are configured to utilize the list of authorized programs when scrambling or descrambling ports.
